(19) United States
(12) Patent Application Publication
(10) Pub. No.: US 2012/0083437 A1
(43) Pub. Date: Apr. 5, 2012

(54) SOLID CLEANING COMPOSITION

(75) Inventors: Barbara G. Choczaj, Apple Valley, MN (US); Steven E. Lentsch, St. Paul, MN (US)

(73) Assignee: ECOLAB USA INC., ST. PAUL, MN (US)

(21) Appl. No.: 12/895,181

(22) Filed: Sep. 30, 2010

(51) Int. Cl. C11D 3/60; C11D 17/08; B28B 1/14; C11D 3/37

(52) U.S. Cl. 510/299; 510/356; 510/324; 510/313; 264/299

(57) ABSTRACT

A solid detergent composition is disclosed including a alcohol ethoxylate surfactant and a sole hardening agent consisting of polyethylene glycol 4000 wherein the composition does not include any free water or alkali metal hydroxides and may include a chlorine-free bleaching agent and activator. The detergent composition may further include citrate, a water conditioner, a sequestrant. The solid detergent composition may be formed into an amorphous solid. Compositions of the invention may further include a crystal modifier consisting of sodium xylene sulfonate. The detergent composition may further optionally include an optical brightener, defoamer, enzyme, antiredeposition agent, buffering agent, stabilizer or combinations thereof.

### FIELD

The invention is directed to a composition and a method for manufacturing homogeneous, eco-friendly, non-caustic, solid cleaning compositions, as for example, laundry detergents that include an alcohol ethoxylate surfactant, a sole hardening agent consisting of polyethylene glycol 4000, and optional additive agents such as detergent adjuvants, a bleaching agent and activator as desired, but contains no free water and no phosphates. The cleaning compositions are prepared in a batch or continuous mixing system, such as an extruder.

### BACKGROUND

The development of solid block cleaning compositions has revolutionized the manner in which detergent compositions are dispensed by commercial and institutional entities that routinely use large quantities of cleaning materials. Solid block compositions offer unique advantages over the conventional liquids, granules or pelletized forms of detergents, including improved handling, enhanced safety, elimination of component segregation during transportation and storage, and increased concentrations of active components within the composition. Because of these benefits, solid block cleaning compositions, such as those disclosed and herein incorporated by reference in U.S. Pat. Nos. RE 32,763, RE 32,818, 4,680,134 and 4,595,520, have quickly replaced the conventional composition forms in commercial and institutional markets.

Various hardening mechanisms have been used in cleaning and sanitizing compositions for converting a fluid composition to a solid mass for containment and modification of the solubility of the active ingredients during use. For example, the active ingredients may be combined with the hardening agent under melting temperatures, commonly referred to as a “molten process,” to achieve a homogeneous mixture, and the melt then poured into a mold and cooled to a solid form. Solid alkaline detergent compositions may also be prepared from an aqueous emulsion of detergent ingredients combined with a solidifying agent that can hydrate to bind free water in the emulsion which, optionally after heating and cooling, hardens to a solid.

The art teaches products formed by heating a mixture containing a chemical sanitizer and a hardening agent such as urea or an alkyl amide such as stearic monoethanolamide or stearic diethanolamide, and decanting the melt into containers. Yet other methods include solid alkaline detergent formed from an aqueous emulsion containing a sodium condensed phosphate hardness sequestering agent and an alkaline builder salt such as sodium hydroxide, which is solidified by incorporating a hydratable hardening agent such as an anhydrous sodium carbonate and/or sodium sulfate. In an embodiment the emulsion is heated to form a molten mass, and then cooled to effect solidification. These methods are undesirable for at least the reason that they contain phosphates and are therefore not eco-friendly. Yet other methods include making solid detergents in the form of a fused block manufactured by preparing a melt of alkali metal silicate, alkali metal hydroxide, optionally water, an active chlorine donor and/or an organic complexing agent, combining the melt with a penta-alkali metal triphosphate, introducing the melt into a flow mixer, and pouring the molten mixture into a mold to solidify.

Solid block laundry detergent compositions provide a significant improvement over the conventional liquid, granular and pelletized detergents. Although the molten process is useful for preparing solid block compositions, time and expense would be saved if heating and cooling of the composition could be minimized or eliminated from the process, and higher viscosities could be used. Also, lower process temperatures would better facilitate the use of heat-sensitive ingredients in cleaning compositions. In addition, less sturdy packaging would be required if the processed mixture could be dispensed at a lower temperature.

Various attempts have been made to manufacture cleaning compositions by an extrusion process. One reference teaches a method of forming a detergent composition having a paste-like consistency, by combining a first aqueous solution containing a potassium tripolyphosphate and a second aqueous solution containing a water-soluble, sodium-based detergent builder, namely sodium hydroxide. Upon mixing, the viscosity of the mixture rapidly increases to form a highly viscous paste. In another extrusion method, an organic detergent of particulate or patty form is formed by kneading together a synthetic organic detergent, a hydratable builder salt such as sodium tripolyphosphate, and water. The mixture is passed through an extruder and forced through openings at or slightly above room temperature and a low pressure to form a rod-shaped extrudate. A disadvantage of these processes is that a caustic, hydratable alkaline source is required to facilitate hardening of the processed composition after extrusion. A further disadvantage is the inclusion of phosphates into the compositions.

An object of the invention is to provide a composition and process for manufacturing a solid, non-caustic cleaning composition that will substantially eliminate swelling of the solid cast or extruded composition and product; includes a sole hardening agent, whereby the proportion of hardening agent in the composition is substantially reduced, and the amount of active ingredients is substantially increased, and the composition does not rely upon hydration in order to solidify. That is, a solid cleaning composition that does not incorporate any free water into the composition. A composition that is substantially free of phosphates is also desired.

### SUMMARY

The invention is directed to a composition and a process for preparing a homogeneous, non-caustic, solid cleaning composition comprising a cleaning agent, detergent adjuvants and additives as desired, a sole hardening agent that is biodegradable, in which no free water is incorporated into the composition.

A detergent composition is provided including a nonionic alcohol ethoxylate surfactant and a hardening agent consisting of polyethylene glycol 4000. The composition does not include any free water in the composition and the detergent is formed in a solid block. Additional optional ingredients include an optical brightener, defoamer, enzyme, chlorine free bleaching agent, bleaching agent activator, antiredeposition agent, buffering agent, stabilizer, or combinations thereof.

In an embodiment the sequestrant includes sodium citrate dehydrate, the brightener includes stilbene disulfonic acid, the bleaching agent and bleach activator includes sodium percarbonate and tetraacetylethylenediamine. In another embodiment a crystal modifier may be included in the composition. The crystal modifier may be selected from the group of sodium phosphonate, tripolyphosphate, sodium xylene sulfonate. In an embodiment of the invention the composition is formed into an amorphous, homogenous solid.

A method of preparing a solid detergent composition is also disclosed. The steps of preparing the solid detergent composition include mixing a fluid detergent composition at shear sufficient to mix the fluid detergent composition having a viscosity of between about 4,000 and about 8,000 cps in a flowable consistency, the detergent composition including (i) an alcohol ethoxylate surfactant, and (ii) a sole hardening agent consisting of polyethylene glycol 4000 and wherein the composition does not include any free water; depositing the detergent composition into molds; and allowing the detergent composition to solidify at a time of between about 1 minute and about 3 hours.

The method of preparing a solid detergent may include a composition further including citrate, a water conditioner, a sequestrant, a crystal modifier selected from the group consisting of sodium phosphonate, tripolyphosphate, sodium xylene sulfonate. The composition may optionally include an optical brightener, defoamer, enzyme, non-chlorine bleaching agent, bleach activator, antiredeposition agent, buffering agent, stabilizer, or combinations thereof.

In an embodiment the sequestrant is comprised of sodium citrate dehydrate, the brightener is comprised of stilbene disulfonic acid, and the bleaching agent and bleach activator is comprised of sodium percarbonate and tetraacetylethylenediamine. In a method according the invention the step of solidifying the fluid detergent composition to a solid form comprises at least one of cooling the fluid detergent composition and allowing a chemical reaction within the fluid detergent composition. In another embodiment the step of solidifying involves casting the fluid detergent composition into a mold. In yet another embodiment the step of solidifying includes extruding the fluid detergent composition into a mold or a packaging system. In a method of the invention the composition is formed into an amorphous block.

The process of the invention includes the steps of (a) mixing an effective amount of a cleaning agent in a continuous mixing system at high shear, at or below the melting temperature of the cleaning agent, to form a substantially homogeneous fluid mixture; (b) discharging the mixture from the mixing system; and (c) allowing the mixture to harden to a solid composition.

The invention provides a method of manufacturing an amorphous homogenous, solid cleaning composition. The processing temperature is at or below the melting temperatures of the ingredients, and the viscosity of the mixture is maintained at about 4,000-8,000 cps. Optionally, external heat may be applied to the mixture up to a temperature of about 150° C. to facilitate processing, for example, during the mixing phase to decrease viscosity of the mixture, during the extruding step, and the like. A sole hardening agent is used in the method of the invention. As such, the method provides a process for making a cleaning composition containing a substantially lower amount of hardening agent and higher amounts of the cleaning agent and other active ingredients than corresponding solid cleaning compositions.

The ingredients may be processed in a continuous processing system capable of mixing the ingredients at high shear to provide a homogeneous mixture, and of retarding solidification and maintaining the composition as a flowable mass during processing. Continuous processing systems useful according to the invention include, for example, a continuous flow mixer, a single- or twin-screw extruder.

A variety of cleaning compositions may be produced according to the present method. In an embodiment the composition is a laundry detergent. The processed composition will comprise an effective cleaning amount of one or more cleaning agents, one or more detergent adjuvants and/or other additives as desired, and a sole hardening agent consisting of polyethylene glycol having a molecular weight of 4,000. The processed composition does not include any free water. In an embodiment the composition includes an unencapsulated bleaching agent and an unencapsulated bleaching agent activator. After processing, the mixture is discharged from the mixing system, as for example, by casting or extruding, and the composition is allowed to harden to a solid form. Advantageously, due to the “cold processing” of the ingredients, the mixture may be cast or extruded directly into a packaging wrapper or casing, or into a mold that may also serve as a dispenser for the composition during use. The mixture is discharged from the mixer at or near ambient temperature, between about 65-80° C. The processed composition “sets up” to a solid form within about 1 minute to about 3 hours, within about 5 minutes to about 1 hour, of being discharged from the mixer. The complete solidification or equilibrium of the processed composition is within about 1-48 hours of being discharged from the mixer, within about 1-36 hours, within about 1-24 hours. Solidification of the composition is substantially simultaneous throughout its mass, and without significant post-solidification swelling.

### DETAILED DESCRIPTION

By the term “solid” as used to describe the processed composition, it is meant that the hardened composition will not flow perceptibly and will substantially retain its shape under moderate stress or pressure or mere gravity, as for example, the shape of a mold when removed from the mold, the shape of an article as formed upon extrusion from an extruder, and the like. The degree of hardness of the solid cast composition may range from that of a fused block solid which is relatively dense and hard, similar to concrete, to a consistency which may be characterized as less dense.

As used herein, the term “antiredeposition agent” refers to a compound that helps keep suspended in water instead of redepositing onto the object being cleaned.

As used herein, the term “phosphate-free” refers to a composition, mixture, or ingredient that does not contain a phosphate or phosphate-containing compound or to which a phosphate or phosphate-containing compound has not been added. Should a phosphate or phosphate-containing compound be present through contamination of a phosphate-free composition, mixture, or ingredients, the amount of phosphate shall be less than 0.5 wt %. More preferably, the amount of phosphate is less than 0.1 wt-%, and most preferably, the amount of phosphate is less than 0.01 wt %.

As used herein, the term “phosphorus-free” refers to a composition, mixture, or ingredient that does not contain phosphorus or a phosphorus-containing compound or to which phosphorus or a phosphorus-containing compound has not been added. Should phosphorus or a phosphorus-containing compound be present through contamination of a phosphorus-free composition, mixture, or ingredients, the amount of phosphorus shall be less than 0.5 wt %. More preferably, the amount of phosphorus is less than 0.1 wt-%, and most preferably the amount of phosphorus is less than 0.01 wt %.

As used herein, the term “caustic-free” refers to a composition, mixture, or ingredient that does not contain an alkali metal hydroxide, particularly does not contain sodium hydroxide, or any hydroxide-containing compound or to which a hydroxide-containing compound has not been added. Should a caustic or caustic-containing compound be present through contamination of a caustic-free composition, mixture, or ingredients, the amount of caustic shall be less than 0.5 wt %. More preferably, the amount of caustic is less than 0.1 wt-%, and most preferably, the amount of caustic is less than 0.01 wt %.

“Cleaning” means to perform or aid in soil removal, bleaching, microbial population reduction, rinsing, or combination thereof.

As used herein, weight percent (wt-%), percent by weight, % by weight, and the like are synonyms that refer to the concentration of a substance as the weight of that substance divided by the total weight of the composition and multiplied by 100.

As used herein, the term “about” modifying the quantity of an ingredient in the compositions of the invention or employed in the methods of the invention refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds. It should also be noted that the term “or” is generally employed in its sense including “and/or” unless the content clearly dictates otherwise.

As used herein, the term “substantially free” refers to compositions completely lacking the component or having such a small amount of the component that the component does not affect the effectiveness of the composition. The component may be present as an impurity or as a contaminant and shall be less than 0.5 wt %. In another embodiment, the amount of the component is less than 0.1 wt-% and in yet another embodiment, the amount of component is less than 0.01 wt %.

As used herein, the phrase “consisting essentially of” refers to a composition including the listed ingredients and/or amounts of listed ingredients and does not include additional ingredients affecting the composition's ability to clean or affect the composition's ability to harden into a solid.

As used herein, the term “bleaching package” refers to a bleaching agent and a bleaching agent activator. In an embodiment the bleaching package is substantially free of chlorine.

The term, “surfactant” as used herein refers to a “surface-active agent”, or a chemical that stabilizes mixtures of oil and water by reducing the surface tension at the interface between the oil and water molecules.

The term, “nonionic” surfactant as used herein refers to a surfactant molecule whose polar group is not electrically charged.

A “nonionic surfactant” is comprised of at least three groups of surfactants, these being (1) alcohol ethoxylates, (2) block polymers or block copolymers, and (3) alcohol alkoxylates. It was surprisingly found that alcohol ethoxylates, when combined with the sole hardening agent polyethylene glycol 4000 in the absence of any free water, form suitable solids for use as detergents.

The term “alcohol ethoxylates” as used herein includes branched or linear molecules. The branched alcohol ethoxylates may be primary, secondary, or tertiary. When referring to alcohol ethoxylates in this application it does not include block polymer or block copolymer nonionic surfactants, it does not include the general alcohol alkoxylates. For purposes of the invention a single alcohol ethoxylate may comprise the nonionic surfactant of the compositions or a combination of two or more alcohol ethoxylates may comprise the nonionic surfactant component of the composition.

The present invention provides a process for manufacturing a variety of solid, non-caustic, cleaning compositions. The method of the invention uses high shear mixing, and a sole hardening agent and lower processing temperatures compared to other known methods for making the cleaning composition by melting the ingredients to achieve a homogeneous mixture. Cleaning compositions which may be prepared according to the method of the invention include, for example, detergent compositions, laundry products, and other like compositions.

The compositions may be produced using a continuous mixing system, such as a single- or twin-screw extruder, by combining and mixing one or more cleaning agents at high shear to form a homogeneous mixture. The processing temperature is at or below the melting temperature of the ingredients. The cleaning composition is prepared by combining an alcohol ethoxylate and PEG 4000 as the hardening agent. The cleaning agent is surprisingly prepared without any free water. That is, no free water of hydration is included in the composition, either as free water or as unbound water provided when adding other ingredients. In an embodiment, the present composition is nonaqueous; it contains no added water beyond any trace or incidental amounts present in the active ingredients, such as water of hydration that is part of an active ingredient. Due to the composition of the invention the method of forming the invention solid does not and cannot rely upon the water of hydration. Therefore, the composition of the invention does not appreciably change size upon solidifying since it is not relying upon evaporation or binding of free water in the composition.

The processed mixture may be dispensed from the mixer by extruding, casting or other suitable means, whereupon the composition hardens to a solid form. Variations in processing parameters may be used to control the development of crystal size and crystalline structure of the matrix and thus the texture of the final product. For example, continuing to shear the mixture while solidification is in progress will create a smaller crystal and a pasty product. The structure of the matrix may be characterized according to its hardness, melting point, material distribution, crystal structure, and other like properties according to known methods in the art. A cleaning composition processed according to the method of the invention is substantially homogeneous with regard to the distribution of ingredients throughout its mass, and also substantially deformation-free.

In addition, hardening of the cleaning composition after processing is accelerated since the end-process temperature of the composition is closer to that required for solidification. The rapid solidification achieved by the present method speeds production of the solid product, and minimizes segregation of the ingredients of the composition, for example by trapping non-compatible ingredients in a matrix of suitably high viscosity and a low temperature to prevent separation. Also, the use of an extruder or similar device provides, for example, continuous processing of a cleaning composition, easy clean-up, and a high level of control and repeatability of the formulation process.

The cleaning compositions of the invention comprise a unique combination of active ingredients. For example, a detergent composition for removing soils and stains include a major amount of a surfactant or surfactant system, as for example, a nonionic surfactant such as an alcohol ethoxylate. An example of such a surfactant includes but is not limited to Surfonic® 24-7, a nonionic surfactant commercially available from Huntsman Corporation located in The Woodlands, Tex., USA. Other examples of nonionic surfactants include Lutensol™ XP50, a Guerbet type, liquid branched alcohol ethoxylate commercially available from BASF; Genopol™ ID 6000 an iso-type alcohol ethoxylate commercially available from Clariant; and Tomadol™ 27-7, laureth-myristeth-7, a liquid linear alcohol ethoxylate commercially available from Thoma (Air Products). Preferably, the composition comprises a surfactant or surfactant system in an amount effective to provide a desired level of soil removal and cleaning, about 10-40 wt-%, about 15-35 wt-%. Preferably, the composition comprises a surfactant or surfactant system in an amount effective to provide a desired level of soil removal and cleaning, about 18-24 wt-%. In yet another embodiment the alcohol ethoxylate is present in compositions of the invention at a level greater than 20 wt-% up to about 35 wt-%. A combination of two or more alcohol ethoxylates may be included in compositions of the invention.

In an embodiment the alcohol ethoxylate is a liquid alcohol ethoxylate. For processing purposes it is believed that the liquid ethoxylates are easier to incorporate into the composition since the composition lacks any free water.

In addition to the nonionic alcohol ethoxylate surfactant, other surfactants may be included in the composition of the invention. A variety of surfactants can be used in a cleaning composition, including anionic, nonionic, cationic and zwitterionic surfactants, which are commercially available from a number of sources. For a discussion of surfactants, see Kirk-Othmer, Encyclopedia of Chemical Technology, Third Edition, volume 8, pages 900-912 herein incorporated by reference. The invention also contemplates an alcohol ethoxylate or a combination of alcohol ethoxylate surfactants as the sole surfactant in the composition. That is, the composition may include a surfactant consisting of an alcohol ethoxylate.

Anionic surfactants useful in the present polyethylene glycol-based cleaning compositions include, for example, carboxylates such as alkylcarboxylates and polyalkoxycarboxylates, alcohol ethoxylate carboxylates, nonylphenol ethoxylate carboxylates, and the like; sulfonates such as alkylsulfonates, alkylbenzenesulfonates, alkylarylsulfonates, sulfonated fatty acid esters, and the like; sulfates such as sulfated alcohols, sulfated alcohol ethoxylates, sulfated alkylphenols, alkylsulfates, sulfosuccinates, alkylether sulfates, and the like; and phosphate esters such as alkylphosphate esters, and the like. Anionics include sodium alkylarylsulfonate, alpha-olefinsulfonate, fatty alcohol sulfates, and the like.

Cationic surfactants useful for inclusion in a cleaning composition for sanitizing include amines such as primary, secondary and tertiary monoamines with C₁₈ alkyl or alkenyl chains, ethoxylated alkylamines, alkoxylates of ethylenediamine, an imidazole such as a 2-alkyl-1-(2-hydroxyethyl)-2-imidazolines, a 1-(2-hydroxyethyl)-2-imidazolines, and the like; and quaternary ammonium salts, as for example, quaternary ammonium chloride surfactants such as n-alkyl(C₁₂-C₁₈) dimethylbenzyl ammonium chloride, n-tetradecyldimethylbenzylammonium chloride monohydrate, a napthylene-substituted quaternary ammonium chloride such as dimethyl-1-napthylmethylammonium chloride, and the like; and other like surfactants.

Also useful for possible inclusion are zwitterionic surfactants such as β-N-alkylaminopropionic acids, N-Alkyl-.beta.-iminodipropionic acids, imidazoline carboxylates, N-alkylbetaines, sultaines, and the like.

Aqueous Medium. The ingredients of the composition are surprisingly not processed in any amount or using any amount of an aqueous medium such as water. That is, the compositions of the invention are substantially free of water. Compositions similar to those of the invention are often processed in an amount of water to provide an effective level of viscosity for processing the mixture, and to provide the processed composition with the desired amount of firmness and cohesion during discharge and upon hardening. This is not the case with compositions of the invention. In fact, compositions of the invention are prepared without any free water and the components used in the formulations of the invention do not include any free water. A hydratable hardening agent is capable of hydrating to bind free water present in a liquid detergent emulsion to the extent that the liquid emulsion becomes hardened or solidified to an amorphous homogenous solid. The amount of a hydratable substance included in a detergent composition varies according to the percentage of water present in the liquid emulsion as well as the hydration capacity of the other ingredients. Compositions of the invention do not rely upon a hydratable hardening agent. Therefore, compositions of the invention are free of any water of hydration and compositions of the invention do not rely upon binding free water or upon evaporation to harden the compositions into a solid form.

Hardening Agent. A sole hardening agent, as used in the present method and compositions, is a compound that significantly contributes to the uniform solidification of the composition. The hardening agent is compatible with the cleaning agent and other active ingredients of the composition, and is capable of providing an effective amount of hardness and/or aqueous solubility to the processed composition. The hardening agent should also be capable of forming a homogeneous matrix with the cleaning agent and other ingredients when mixed and solidified to provide a uniform dissolution of the cleaning agent from the solid composition during use.

The cleaning compositions of the invention ideally employ a sole hardening agent. In an embodiment the hardening agent is compatible with the alcohol ethoxylate surfactant and together form a solid composition. In a preferred embodiment the hardening agent consists of polyethylene glycol. It has surprisingly been found that polyethylene glycol having a molecular weight of 4,000 (hereinafter PEG 4000) is superior to other polyethylene glycols and, in particular, is superior to PEG 8000. PEG 4000 as opposed to PEG 8000 formed a solid block having a good consistency. By “good consistency” it is meant that the solid retained a block shape yet was not overly brittle. That is, the solid containing PEG 4000 did not crumble or break nor was it too fragile to handle or for shipment. In contrast, when PEG 8000 was used to formulate similar compositions, the solids were too brittle and exhibited crumbling which was unsuitable to handle as shown in the Examples below. Solid polyethylene glycols which are useful are marketed under the trademark Pluriol™ and are commercially available from BASF or Carbowax™ commercially available from Dow.

The hardening agent PEG 4000 is desirable for at least a couple of reasons beyond the solidification and reduced brittleness of the solid. First, it allows a high level of the surfactant or cleaning agent to be incorporated into the composition. Second, it is fully biodegradable allowing a formulation to be environmentally safe and friendly. In an embodiment the PEG 4000 used to prepare compositions of the invention has a melting point of 140° F. or higher. Between about 2-30 weight percent, 3-20 weight percent, and 5-10 weight percent PEG 400 is included in compositions.

The amount of hardening agent included in the cleaning composition will vary according to the type of cleaning composition being prepared, the ingredients of the composition, the intended use of the composition, the quantity of dispensing solution applied to the solid composition over time during use, the temperature of the dispensing solution, the hardness of the dispensing solution, the physical size of the solid composition, the concentration of the other ingredients, the concentration of the cleaning agent in the composition, and other like factors. The amount of the hardening agent is effective to combine with the cleaning agent and other ingredients of the composition to form a homogeneous mixture under continuous mixing conditions.

A nonionic alcohol ethoxylate is used in the present formulation; the ratio of surfactant to PEG4000 is 3.7:1 or less, 2.5:1 or less, 1.5:1 or less. In an embodiment the hardening agent will form a matrix with the cleaning agent and other ingredients which will harden to a solid form under ambient temperatures of about 60° to 80° F., about 65-75° F., about 68° to 72° F. after mixing ceases and the mixture is dispensed from the mixing system, within about 1 minute to about 3 hours, about 2 minutes to about 2 hours, about 5 minutes to about 1 hour. A minimal amount of heat from an external source may be applied to the mixture to facilitate processing of the mixture. The amount of the hardening agent included in the composition is effective to provide a hardness and desired rate of controlled solubility of the processed composition when placed in an aqueous medium to achieve a desired rate of dispensing the cleaning agent from the solidified composition during use. The hardening agent is present in an amount of about 5-30 wt-%, about 8-27 wt-%, about 10-18 wt-%.

Other hardening agents commonly used in solid cleaning compositions that are not employed in the cleaning composition of the invention include, for example, urea, also known as carbamide, starches that have been made water-soluble through an acid or alkaline treatment process.

Additive Agents. The cleaning compositions may further include conventional detergent adjuvants such as a chelating agent, bleaching agent, bleach activator, buffering agent, stabilizer, alkaline source, enzyme, detergent filler, defoamer, anti-redeposition agent, a threshold agent or system, aesthetic enhancing agent (i.e., dye, perfume), and other like additives. Adjuvants and other additive ingredients will vary according to the type of composition being manufactured. It should be noted that compositions of the invention are substantially free of any secondary hardening agents and are also substantially free of any free water or water of hydration.

Sequestering Agents. The composition may include a sequestering agent such as an amino carboxylic acid, a condensed phosphate, a phosphonate, a polyacrylate, and the like. In general, a sequestering agent is a molecule capable of coordinating (i.e., binding) the metal ions commonly found in natural water to prevent the metal ions from interfering with the action of the other detersive ingredients of a cleaning composition. Depending on the type of cleaning composition being formulated, a sequestering agent is optionally included in an amount of about 0.1-70 wt-%, from about 5-50 wt-%, from about 10-40 wt-%, and from about 25-35 wt-%.

A class of sequestrant of the invention includes citrates and in an embodiment, sodium citrate dihydrate. Since the compositions of the invention do not rely upon water of hydration, or urea in order to solidify, they may include water-conditioning agents such as sequestrants. If water-conditioning agents are included in urea-containing compositions, they prevent crystallization. Therefore, due to the sole hardening agent of the composition of the invention being PEG 4000, the compositions are substantially free of urea and may include water-conditioning agents or sequestrants.

Useful aminocarboxylic acids include, for example, n-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), and the like. The invention contemplates a phosphate or phosphonate free composition.

Polyacrylates suitable for use as cleaning agents include, for example, polyacrylic acid, polymethacrylic acid, acrylic acid-methacrylic acid copolymers, hydrolyzed polyacrylamide, hydrolyzed polymethacrylamide, hydrolyzed polyamide-methacrylamide copolymers, hydrolyzed polyacrylonitrile, hydrolyzed polymethacrylonitrile, hydrolyzed acrylonitrile-methacrylonitrile copolymers, and the like. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein.

Bleaching agents. Bleaching agents that may be used in a cleaning composition for lightening or whitening a substrate, include bleaching compounds capable of liberating an active halogen species, such as—Br, and/or —OBr, under conditions typically encountered during the cleansing process. Suitable bleaching agents for use in the present cleaning compositions include, for example, chlorine-free compounds. A bleaching agent may also be a peroxygen or active oxygen source such as hydrogen peroxide, perborates, sodium carbonate peroxyhydrate, sodium percarbonate, phosphate peroxyhydrates, potassium permonosulfate, and sodium perborate mono and tetrahydrate, with and without activators such as tetraacetylethylene diamine, and the like. In an embodiment the bleaching agent and bleaching agent activator are both provided in encapsulated format. However, due to the composition's lack of any free water or any water of hydration, it is believed that the bleaching agent and bleaching agent activator may both be provided in unencapsulated format. It is surprising that a solid cleaning composition could contain a chlorine-free unencapsulated bleaching agent and an unencapsulated activator. A cleaning composition may include a minor but effective amount of a chlorine-free bleaching agent, about 0.1-40 wt-%, about 5-30 wt-%, about 15-25 wt-%. A cleaning composition may include a minor but effective amount of a bleach activator, about 0.1-20 wt-%, about 1-15 wt-%, about 5-13 wt-%, about 7-11 wt-%.

Alkaline Sources. The cleaning composition produced according to the invention may include minor but effective amounts of one or more alkaline sources to enhance cleaning of a substrate and improve soil removal performance of the composition. It is noted that compositions of the invention are substantially free of caustic component.

Detergent Fillers. A cleaning composition may include a minor but effective amount of one or more of a detergent filler, which does not perform as a cleaning agent per se, but cooperates with the cleaning agent to enhance the overall cleaning action of the composition. Examples of fillers suitable for use in the present cleaning compositions include sodium sulfate, sodium chloride, starch, sugars, and C₁-C₁₀ alkylene glycols such as propylene glycol, and the like. The filler is included in an amount of about 1-20 wt-%, about 3-15 wt-%.

Defoaming Agents. A minor but effective amount of a defoaming agent for reducing the stability of foam may also be included in a cleaning composition. The cleaning composition includes about 0.0001-5 wt-% of a defoaming agent, about 0.01-1 wt-%.

Examples of defoaming agents suitable for use in the present compositions include silicone compounds such as silica dispersed in polydimethylsiloxane, fatty amides, hydrocarbon waxes, fatty acids, fatty esters, fatty alcohols, fatty acid soaps, ethoxylates, mineral oils, polyethylene glycol esters, alkyl phosphate esters such as monostearyl phosphate, and the like. A discussion of defoaming agents may be found in U.S. Pat. No. 3,048,548 to Martin et al., U.S. Pat. No. 3,334,147 to Brunelle et al., and U.S. Pat. No. 3,442,242 to Rue et al., the disclosures of both references are incorporated by reference herein.

Anti-redeposition Agents. A cleaning composition may also include an anti-redeposition agent capable of facilitating sustained suspension of soils in a cleaning solution and preventing removed soils from being redeposited onto the substrate being cleaned. Examples of suitable anti-redeposition agents include fatty acid amides, fluorocarbon surfactants, complex phosphate esters, styrene maleic anhydride copolymers, and cellulosic derivatives such as hydroxyethyl cellulose, hydroxypropyl cellulose, carboxymethyl cellulose, and the like. A cleaning composition may include about 0.01-10 wt-%, about 0.05-5 wt-%, about 0.1-3 wt-% of an anti-redeposition agent. The composition can include any of these ranges or amounts not modified by about.

Dyes/Odorants. Various dyes, odorants including perfumes, and other aesthetic enhancing agents may also be included in the composition. Dyes may be included to alter the appearance of the composition, as for example, Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical Co.), Fluorescein (Capitol Color and Chemical), Rhodamine (D&C Red No. 19), Sap Green (Keystone Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Acid Green 25 (Ciba-Geigy), and the like.

Fragrances or Perfumes. Fragrances or perfumes that may be included in the compositions include, for example, terpenoids such as citronellol, aldehydes such as amyl cinnamaldehyde, a jasmine such as C1S-jasmine or jasmal, vanillin, and the like.

Optical Brighteners. Optical brighteners may be included in compositions of the invention. Optical brighteners, which can also be referred to as fluorescent whitening agent or fluorescent brightening agent, provide optical compensation for the yellow cast in fabric substrates. With optical brighteners yellowing is replaced by light emitted from optical brighteners present in the area commensurate in scope with yellow color. The violet to blue light supplied by the optical brighteners combines with other light reflected from the location to provide a substantially complete or enhanced bright white appearance. This additional light is produced by the brightener through fluorescence. Optical brighteners can absorb light in the ultraviolet range (e.g., 275-400 nm) and can emit light in the ultraviolet blue spectrum (e.g., 400-500 nm).

Fluorescent compounds belonging to the optical brightener family are typically aromatic or aromatic heterocyclic materials often containing condensed ring system. An important feature of these compounds is the presence of an uninterrupted chain of conjugated double bonds associated with an aromatic ring. The number of such conjugated double bonds is dependent on substituents as well as the planarity of the fluorescent part of the molecule. Most brightener compounds are derivatives of stilbene or 4,4′-diamino stilbene, biphenyl, five membered heterocycles (triazoles, oxazoles, imidazoles, etc.) or six membered heterocycles (cumarins, naphthalamides, triazines, etc.). The choice of optical brighteners for use in detergent compositions will depend upon a number of factors, such as the type of detergent, the nature of other components present in the detergent composition, the temperature of the wash water, the degree of agitation, and the ratio of the material washed to the tub size. The brightener selection is also dependent upon the type of material to be cleaned, e.g., cottons, synthetics, etc. Since most laundry detergent products are used to clean a variety of fabrics, the detergent compositions should contain a mixture of brighteners which are effective for a variety of fabrics. It is of course necessary that the individual components of such a brightener mixture be compatible.

Optical brighteners useful in the present invention are known and commercially available. Commercial optical brighteners which may be useful in the present invention can be classified into subgroups, which include, but are not necessarily limited to, derivatives of stilbene, pyrazoline, coumarin, carboxylic acid, methinecyanines, dibenzothiophene-5,5-dioxide, azoles, 5- and 6-membered-ring heterocycles and other miscellaneous agents. Examples of these types of brighteners are disclosed in “The Production and Application of Fluorescent Brightening Agents”, M. Zahradnik, Published by John Wiley & Sons, New York (1982), the disclosure of which is incorporated herein in its entirety by reference for all purposes.

Stilbene derivatives which may be useful in the present invention include, but are not necessarily limited to, derivatives of bis(triazinyl)amino-stilbene; bisacylamino derivatives of stilbene; triazole derivatives of stilbene; oxadiazole derivatives of stilbene; oxazole derivatives of stilbene; and styryl derivatives of stilbene. In an embodiment, optical brighteners include stilbene derivatives.

A cleaning composition of the invention can include, for example, about 0 to about 2 wt-%, about 0.05 to about 1 wt-%, about 0.1 to about 0.5 wt-%, or about 0.1 to about 0.2 wt-% optical brightener. In an embodiment, the optical brightener is present at about 0.1 wt-% or at about 0.25 wt-%. The composition can include any of these ranges or amounts not modified by about.

Compositions are provided in the table below.

| | Percent by | Percent by | Percent by |
|---|---|---|---|
| Component | Weight | Weight | Weight |
| Nonionic Surfactant | 5-50 | 10-40 | 20-35 |
| (Alcohol ethoxylate) | | | |
| Solidification Agent | 2-30 | 3-20 | 5-10 |
| (Polyethylene Glycol | | | |
| 4000) | | | |
| Sequestrant/Filler | 0-70 | 5-50 | 25-35 |
| Antiredeposition | 0-5 | 0.1-3 | 0.5-2 |
| Agent | | | |
| pH Adjuster | 0-10 | 0.1-5 | 0.5-3 |
| Brightening Agent | 0-1 | 0.01-1 | 0.05-1 |
| Thickening Agent | | | |
| Defoaming Agent | 0-5 | 0.001-2 | 0.01-1 |
| Bleaching Agent | 0-25 | 5-20 | 10-20 |
| Bleaching Agent | 0-20 | 1-15 | 5-10 |
| Activator | | | |
| Enzyme | 0-3 | 0.1-2 | 0.15-1.5 |
| Fragrance | 0-3 | 0.1-2 | 0.15-1 |
| Dye | 0-3 | 0.1-2 | 0.15-1 |
| Ratio of Alcohol | 3.7:1-1.5:1 | 3.0-1.5:1 | 2.5:1-1.5:1 |
| Ethoxylate | | | |
| Surfactant:PEG 4000 | | | |
| Hardening Agent | | | |

Exemplary compositions are provided in the table below.

| | | Compo- | Compo- | Compo- |
|---|---|---|---|---|
| | | sition | sition | sition |
| Component | Tradename | I - Wt-% | II - Wt-% | III |
| Alcohol ethoxylate | Lutensol | 17 | 17 | 5 |
| | XP50¹ | | | |
| Alcohol ethoxylate | — | — | — | 15 |
| (linear C12-C15) | | | | |
| Alcohol ethoxylate | — | — | — | 7 |
| (C12-C14) 3EO | | | | |
| Polyethylene | Pluriol | 16.41 | 16.41 | 6 |
| Glycol | E4000² | | | |
| Alcohol ethoxylate | Tomadol | 5 | 5 | |
| (Surfactant) | 25-7³ | | | |
| Sodium | — | 25 | 12 | — |
| CitrateDihydrate | | | | |
| (Filler/Sequestrant) | | | | |
| Sodium | — | 1 | 1 | 1 |
| Carboxymethyl | | | | |
| Cellulose | | | | |
| (Anti-redeposition | | | | |
| Agent) | | | | |
| Sodium Chloride | — | — | 13 | — |
| (Filler) | | | | |
| Soda Ash | — | — | — | 13.21 |
| (Monohydrate) | | | | |
| (pH Adjuster) | | | | |
| Sodium | — | — | — | 36.08 |
| aluminosilicate | | | | |
| (Water | | | | |
| Conditioner) | | | | |
| Stilbene Disulfonic | — | 0.1 | 0.1 | 0.1 |
| Acid | | | | |
| (Brightening | | | | |
| Agent) | | | | |
| Sodium | — | 2.25 | 2.25 | 2.5 |
| Polyacrylate | | | | |
| (Water | | | | |
| Conditioner) | | | | |
| Sodium carbonate | — | 2.39 | 2.39 | 13.21 |
| Silicone Defoamer | — | 0.01 | — | — |
| Sodium | FB 400 C⁴ | 20 | 20 | — |
| Percarbonate | | | | |
| TAED | — | 9.84 | 9.84 | — |
| Enzyme | Purafect | 1 | 1 | 0.6 |
| | 4000L⁵ | | | |
| Fragrance | — | — | — | 0.3 |

¹Available from BASF, a Guerbet type, liquid branched alcohol ethoxylate
²Available from BASF
³Available from Thoma (Air Products), laureth/myristeth-7, a liquid alcohol ethoxylate
⁴Coated sodium percarbonate available from Solvay
⁵Available from Genencor

The Surfactant to polyethylene glycol ratio for both Composition I and II provided above was 1.34:1. Both Compositions provided satisfactory blocks meaning that the blocks were solid yet were not crumbly or brittle.

Processing of the Composition. The invention provides a method of processing non-caustic cleaning compositions at lower temperatures and higher viscosities than are typically used when processing the same or similar composition by other methods such as a molten process.

Although not intended to limit the scope of the invention, it is believed that, at least in part and at least in one embodiment, the continuous mixing of the ingredients of the cleaning composition at high shear enables the composition to be processed at a significantly lower temperature than that needed in other processing methods by which the ingredients of the composition are melted to form a homogeneous mixture. It is also believed that the continuous mixing of the ingredients enables the amount of the hardening agent required for effective hardening of a composition to be substantially reduced from that typically needed for preparing the corresponding cleaning compound by a molten process or other known method.

The mixing system provides for continuous mixing of the ingredients at high shear to form a substantially homogeneous liquid or semi-solid mixture in which the ingredients are distributed throughout the mass. The mixing system includes means for mixing the ingredients to provide shear effective for maintaining the mixture at a flowable consistency such that the mixture can be stirred, mixed, agitated, blended, poured, extruded, and/or molded in conventional industrial mixing and/or shearing equipment of the type suitable for continuous processing and uniform distribution of ingredients in a mixture. The viscosity of the mixture during processing is about 1,000-1,000,000 cps, about 2,000-200,000 cps, about 3,000-50,000 cps, about 3,500-10,000 cps, about 4,000-8,000 cps. The viscosity of the composition can include any of these ranges or amounts not modified by about. The mixing system is a continuous flow mixer, as for example, a Teledyne continuous processor, a Beardsley Piper continuous mixer, a single- or twin-screw extruder.

In an embodiment the mixture is processed at a temperature lower than the melting temperature of the ingredients of the composition, below about 55 to about 65.5° C. Although minimal heat may be applied to the mixture during processing, it can be appreciated that the temperature achieved by the mixture may become elevated during processing due to variances in processing conditions, and/or by an exothermic reaction between ingredients. Optionally, the temperature of the mixture may be increased, for example at the inlets or outlets of the mixing system, by applying heat from an external source to achieve a temperature of about 50-68° C., about 55-70° C., to facilitate processing of the mixture. It is desirable to maintain the temperature of the composition below about 150 degrees F. or below about 140 degrees F. which is the melting temperature of the polyethylene glycol 4000. If the melting temperature of the polyethylene glycol 4000 is exceeded, the composition may not harden suitably.

In general, in a continuous batch the composition is processed at a pressure of about 5-150 psig, about 10-30 psig. The pressure may be increased up to about 30-6000 psig to maintain fluidity of the mixture during processing, to provide a force effective to urge the mixture through the mixer and discharge port, and the like.

An ingredient may be in the form of a liquid or solid such as a dry particulate, and may be added to the mixture separately or as part of a premix with one or more other ingredient, as for example, the cleaning agent, aqueous medium, and additional ingredients such as a second cleaning agent, a detergent adjuvant or other additive, a hardening agent, and the like. One or more premixes may be added to the mixture.

As previously discussed, an aqueous medium is not included in the mixture. An aqueous medium is not included in the mixture as a separate ingredient or as part of a liquid ingredient or premix.

The ingredients are mixed together at high shear to form a substantially homogenous consistency wherein the ingredients are distributed substantially evenly throughout the mass. The mixture is then discharged from the mixing system by casting into a mold or other container, by extruding the mixture, and the like. The mixture is cast or extruded into a mold or other packaging system that can optionally be used as a dispenser for the composition. The temperature of the mixture when discharged from the mixing system is sufficiently low to enable the mixture to be cast or extruded directly into a packaging system without first cooling the mixture. The mixture at the point of discharge is at about ambient temperature, about 65-75° F., about 68-72° F. The composition is then allowed to harden to a solid form such as that of a high density, fused solid, concrete-like block for example.

In a method according to the invention, the mixing system may be a twin-screw extruder which houses two adjacent parallel rotating screws designed to co-rotate and intermesh, the extruder having multiple barrel sections and a discharge port through which the mixture is extruded. The extruder may include, for example, one or more feed or conveying sections for receiving and moving the ingredients, a compression section, mixing sections with varying temperature, pressure and shear, a die section, and the like. Suitable twin-screw extruders can be obtained commercially and include for example, Buhler Miag Model No. 62 mm available from Buhler Miag located in Plymouth, Minn.

Extrusion conditions such as screw configuration, screw pitch, screw speed, temperature and pressure of the barrel sections, shear, throughput rate of the mixture, water content, die hole diameter, ingredient feed rate, and the like, may be varied as desired in a barrel section to achieve effective processing of ingredients to form a substantially homogeneous liquid or semi-solid mixture in which the ingredients are distributed evenly throughout. To facilitate processing of the mixture within the extruder, it is desirable that the viscosity of the mixture is maintained at about 1,000-1,000,000 cps, about 2,000-200,000 cps, about 3,000-50,000 cps, about 3,500-10,000 cps, about 4,000-8,000 cps. The viscosity of the composition can include any of these ranges or amounts not modified by about.

The extruder comprises a high shear screw configuration and screw conditions such as pitch, flight (forward or reverse) and speed effective to achieve high shear processing of the ingredients to a homogenous mixture. In an embodiment the screw comprises a series of elements for conveying, mixing, kneading, compressing, discharging, and the like, arranged to mix the ingredients at high shear and convey the mixture through the extruder by the action of the screw within the barrel section. The screw element may be a conveyor-type screw, a paddle design, a metering screw, and the like. A useful screw speed is about 20-250 rpm, about 40-150 rpm.

Optionally, heating and cooling devices may be mounted adjacent the extruder to apply or remove heat in order to obtain a desired temperature profile in the extruder. For example, an external source of heat may be applied to one or more barrel sections of the extruder, such as the ingredient inlet section, the final outlet section, and the like, to increase fluidity of the mixture during processing through a section or from one section to another, or at the final barrel section through the discharge port. The temperature of the mixture during processing including at the discharge port, is maintained at or below the melting temperature of the ingredients, below about 150° or below about 140° F.

In the extruder, the action of the rotating screw or screws will mix the ingredients and force the mixture through the sections of the extruder with considerable pressure. Pressure may be increased up to about 6,000 psig, up to about 5-150 psig, in one or more barrel sections to maintain the mixture at a desired viscosity level or at the die to facilitate discharge of the mixture from the extruder.

The flow rate of the mixture through the extruder will vary according to the type of machine used. In general, a flow rate is maintained to achieve a residence time of the mixture within the extruder effective to provide substantially complete mixing of the ingredients, to a homogenous mixture, and to maintain the mixture at a fluid consistency effective for continuous mixing and eventual extrusion from the mixture without premature hardening.

When processing of the ingredients is complete, the mixture may be discharged from the extruder through the discharge port, in an embodiment, a die. The pressure may also be increased at the discharge port to facilitate extrusion of the mixture, to alter the appearance of the extrudate, for example, to expand it, to make it smoother or grainier in texture as desired, and the like.

In an alternate embodiment the composition is prepared in batches. The components are charged into a stainless steel mixer fitted with a heating jacket. When preparing the composition as batches, the final composition is poured into molds. In an embodiment these molds are high density polyethylene cylinders. When depositing the composition into such molds, it is desirable that the composition is cool enough such that the molds do not melt. In an embodiment the temperature of the composition upon depositing into such molds is below about 125 degrees F., below about 122 degrees F., or below about 120 degrees F.

The cast or extruded composition eventually hardens due, at least in part, to cooling and/or the chemical reaction of the ingredients. The solidification process may last from a few minutes to about 2-3 hours, depending, for example, on the size of the cast or extruded composition, the ingredients of the composition, the temperature of the composition, and other like factors. The cast or extruded composition “sets up” or begins to harden to a solid form immediately. The cast or extruded composition is completely hardened within about 1 minute to about 3 hours, about 5 minutes to about 2 hours, about 10 minutes to about 1½ hours, or about 15 minutes to about 75 minutes. As one skilled in the art will appreciate, the time taken for the composition to completely harden is dependent both upon the size of the mold and the temperature of the composition upon depositing into the mold or upon extrusion.

Packaging System. The processed compositions of the invention may be cast or extruded into temporary molds from which the solidified compositions may be removed and transferred for packaging. The compositions may also be cast or extruded directly into a packaging receptacle. Extruded material may also be cut to a desired size and packaged, or stored and packaged at a later time.

The packaging receptacle or container may be rigid or flexible, and composed of any material suitable for containing the compositions produced according to the invention, as for example, glass, steel, plastic, cardboard, cardboard composites, paper, and the like. In an embodiment a receptacle is a container comprised of a polyolefin such as high density polyethylene or low density polyethylene.

Advantageously, since the final temperature of the composition is at a relatively low temperature for solid detergents, the temperature of the processed mixture is low enough so that the mixture may be cast or extruded directly into the container or other packaging receptacle without structurally damaging the receptacle material. As a result, a wider variety of materials may be used to manufacture the container than those used for compositions that processed and dispensed under molten conditions.

The packaging used to contain the compositions may be manufactured from a material which is biodegradable and/or water-soluble during use. Such packaging is useful for providing controlled release and dispensing of the contained cleaning composition. Biodegradable materials useful for packaging the compositions of the invention include, for example, water-soluble polymeric films comprising polyvinyl alcohol, as disclosed for example in U.S. Pat. No. 4,474,976 to Yang; U.S. Pat. No. 4,692,494 to Sonenstein; U.S. Pat. No. 4,608,187 to Chang; U.S. Pat. No. 4,416,793 to Haq; U.S. Pat. No. 4,348,293 to Clarke; U.S. Pat. No. 4,289,815 to Lee; and U.S. Pat. No. 3,695,989 to Albert, the disclosures of which are incorporated by reference herein for all purposes.

In addition, the mixture may be cast into a variety of shapes and sizes by extrusion since the viscosity of the mixture can be varied, for example, according to the amount of shear applied during mixing, the amount of hardening agent and water in the composition ingredients, temperature of the mixture, and other like factors. Also, unlike the “molten process,” since the mixture is processed at a relatively low temperature, reduced cooling of the composition is required prior to or after casting or extruding. The reduced temperature of the discharged material also enhances safety for those handling the material.

Dispensing of the processed compositions. A cleaning composition made according to the present invention may be dispensed from a spray-type dispenser such as that disclosed in U.S. Pat. Nos. 4,826,661, 4,690,305, 4,687,121, and 4,426,362, the disclosures of which are incorporated by reference herein for all purposes in their entirety. Briefly, a spray-type dispenser functions by impinging a water spray upon an exposed surface of the solid composition to dissolve a portion of the composition, and then immediately directing the concentrate solution comprising the composition out of the dispenser to a storage reservoir or directly to a point of use.

The invention will be further described by reference to the following detailed examples. These examples are not meant to limit the scope of the invention that has been set forth in the foregoing description. Variations within the concepts of the invention are apparent to those skilled in the art.

Sample solid detergents were prepared according to the compositions provided in the Examples below. The compositions were prepared by first combining a alcohol ethoxylate and polyethylene glycol 4000 in a stainless steel, jacketed mix tank. The mix tank was heated to about 120-150 degrees F., in an embodiment 130-140 degrees F. and the combination was mixed until uniform. A dispersing agent was then added to the mix tank while mixing. Next, a brightening agent, pH adjuster, and a water conditioning agent were added to the mix tank and the combination was mixed for at least 10 minutes or until a uniform mixture was obtained. The batch temperature was then adjusted to between about 110 to about 135 degrees F., between about 120 to about 125 degrees F. An antifoaming agent was then added slowly to the combination and mixed until uniform. After addition of the antifoaming agent the temperature of the mix tank was maintained at between about 130-140 degrees F. The combination noticeably thickened and the agitation of the mixer was increased to maintain flow within the tank. The bleaching agent was then added and the combination was mixed for five minutes and the temperature of the mix tank was reduced to between about 115 to about 120 degrees F., or about 118 degrees F. At this time the target pH of the combination was checked by making a 1% by weight in water solution and in an embodiment the pH is between about 8-11, between about 9-10. The bleaching agent activator was next slowly added to the mix tank. A final temperature of the combination was between about 115 to about 118 degrees F. Within the target temperature the combination did not separate. If an enzyme was included in the composition it was added slowly at this time while mixing and while maintaining the temperature at between about 110 to about 115 degrees F. The prepared composition was deposited into product tubs having a volume of about 40 to 50 ounces each. The packaged tubs were forced into an air chiller having a temperature of about 10 degrees F. or less for at least about 20 minutes. The cooled blocks were then removed from the tubs.

The following tests were run on the each of the solid blocks to determine stability and efficacy of the detergent: (1) Stability after storage at 100° F., measurement taken at 100° F.; (2) Stability after storage at 100° F. after cooling to ambient temperature; (3) Stability after storage at 122° F., measurement taken at 122° F.; (4) Stability after storage at 122° F. after cooling to ambient temperature (5) Hardness at 100° F. and at ambient temperature, (6) pH at 100° F., (7) Detergency. The methods of these tests are provided below.

Stability after storage at 122 degrees F. Sample compositions were placed at 122° F. for a four week period. On a weekly basis, compositions were removed and data was collected. The samples were visually inspected for cracks, separation, discoloration, and melting. If cracks developed, separation of the composition occurred, discoloration occurred, or if the sample melted, the sample was said to have failed. Additionally, the pH profile of the sample was taken and a pop out test was run (pH and pop out test protocols are described below).

Cycling Conditions

In order to test how a composition would fair over extended times and fluctuating conditions as are commonly found for holding conditions, samples were subjected to the following cycling conditions. Samples were placed at 100° F. for 24 hours. The temperature was then reduced to ambient temperature, between about 68° to about 72° F. for 24 hours. The temperature was then raised to 100° F. for 24 hours and the cycle was repeated for 28 days. Samples were removed on a weekly basis to determine hardness. Penetrometer readings were taken both at 100° F. and at 70° F.

Separation

Separation of the samples was visually observed. After removing the sample from the 122° F. temperature or the cycling conditions (alternating between ambient temperature and 100° F.), a sample was viewed to determine if separation had occurred. If the composition remained in a single phase it was said not to separate. If the composition became biphasic or triphasic it was said to separate. Separation of a sample was undesirable and sample was said to fail if it exhibited any separation.

Pop Out Test

The Pop Out Test was run to determine whether or not the solid was easily removed from its container or tub. A positive result from the pop out test was a sample that remained in one piece without cracking upon removal and did not leave appreciable residue in the container.

For containers holding samples of less than 6 pounds the container was inverted and the bottom of the container was pushed once with the heels of the hands. An acceptable sample popped out of the container and left no appreciable residue in the container.

For containers of greater than 6 pounds the container lid was removed and the container including the sample was inverted onto a surface. The inverted container was raised 6 to 8 inches and dropped. If the sample did not release from the container after 10 seconds, the drop was repeated. A sample that released cleanly and left no appreciable residue in the container had acceptable pop out test results.

Hardness

Hardness was tested by the depth that a penetrometer needle sank into the solid. A “Precision” Model Penetrometer available from Humboldt Manufacturing was fitted with a #73520 needle. A sample composition was brought to ambient temperature (about 68 to about 72 degrees F.) by placing the sample composition in a glass beaker and placing the beaker into a 70 degree F. water bath for about 20 minutes. After the temperature of the sample reached 70 degrees F., the sample composition was removed from the beaker and placed on the penetrometer stand such that the point of the needle was over and barely contacting the sample. The penetrometer trigger was depressed for 5 seconds and then released. The depth of the needle penetration was measured. Three readings were taken for each sample and results were provided in millimeters. Therefore, a harder sample had less penetration of the penetrometer needle than a softer sample. Harder samples had lower penetrometer results while softer samples had higher penetrometer results.

pH

For each sample, the pH was taken of a 1 weight % solution in water using a standard pH meter.

Soil Removal or Detergency

Soil removal or detergency capabilities of compositions prepared according to the Examples were tested according to the following procedure.

Pre-soiled cotton and cotton/polyester blended fabrics were purchased from Testfabrics, Inc. located in West Pittston, Pa. For each swatch the initial transmittance was taken in duplicate using a HunterLab UltraScan Color Quest XE available from Hunter Labs. A residential 20 pound capacity washing machine manufactured by Whirlpool or Maytag was loaded with the soiled test swatches and laundry fill consisting of about 18 pounds of white polyester/cotton blend pillowcases and/or sheets. Twenty grams of the solid detergent sample composition prepared according to the Examples was crumbled and added to the washing machine. A regular wash cycle (of about 9 minutes) was run using a warm wash (95° to 100° F.) with 5 grain water. The wash was followed by a cold rinse. The load was spun to remove rinse water. Swatches were removed from the machine, flattened, and hung to dry.

Duplicate readings were taken for each swatch using the HunterLab UltraScan and the two readings were averaged. Percent soil removal was calculated as follows:

L*(Initial)−L*(Final)×100=% Soil Removal

96−L*(Initial)

wherein L* is the light transmittance with a reading of 0 being black and the highest or lightest reading being 96; L*(Initial)=Average number of initial readings per swatch; L*(Final)=Average of the final readings per swatch.

### Example 1

Composition 1 and Comparative Composition A were prepared according to the formulae provided in the following table. This Example shows that suitable solid block detergents were prepared using a liquid alcohol ethoxylated and polyethylene glycol having a molecular weight of 4,000 (PEG 4000). Trading the PEG 4000 with PEG 8000 did not result in an acceptable solid block detergent.

| | | | Comparative |
|---|---|---|---|
| | | Composition | Composition |
| Component | Tradename | 1 Wt-% | A Wt-% |
| Alcohol ethoxylate | Surfonic 24-7¹ | 22 | 22 |
| Polyethylene Glycol | Pluriol E4000² | 14.41 | 0 |
| | Pluriol E8000^{2a} | 0 | 14.41 |
| Sodium | | 27 | 27 |
| CitrateDihydrate | | | |
| Sodium | | 1 | 1 |
| Carboxymethyl | | | |
| Cellulose 95% | | | |
| Stilbene Disulfonic | | 0.1 | 0.1 |
| Acid | | | |
| Sodium Polyacrylate | | 2.25 | 2.25 |
| Sodium carbonate | | 2.39 | 2.39 |
| Silicone Defoamer | | 0.01 | 0.01 |
| Sodium Percarbonate, | FB 400 C⁴ | 20 | 20 |
| encapsulated | | | |
| TAED | | 9.84 | 9.84 |
| Enzyme | Purafect 4000L⁵ | 1 | 1 |
| Alcohol Ethoxylate: | | 1.53 | 1.53 |
| PEG 4000 ratio | | | |
| Satisfactory Block | | Yes | No - Too brittle |

¹Available from Huntsman Chemical - laureth/myristeth -7, a liquid alcohol ethoxylate
²Available from BASF having a molecular weight of 4,000
^{2a}Available from BASF having a molecular weight of 8,000
³Available from Thoma (Air Products), laureth/myristeth-7, a liquid alcohol ethoxylate
⁴Coated sodium percarbonate available from Solvay
⁵Available from Genencor

Composition 1 produced a satisfactory solid block whereas Comparative Composition A produced a block which was too brittle for packaging and transport.

### Example 2

Composition 2 and Comparative Composition B were prepared according to the formulae provided in the table below. This Example shows that suitable solid block detergents were prepared using a Guerbet-type liquid branched alcohol ethoxylate and polyethylene glycol having a molecular weight of 4,000 (PEG 4000). Trading the PEG 4000 with PEG 8000 did not result in an acceptable solid block detergent.

| | | | Comparative |
|---|---|---|---|
| | | Composition | Composition |
| Component | Tradename | 2 Wt-% | B Wt-% |
| Alcohol ethoxylate | Lutensol XP 50¹ | 22 | 22 |
| Polyethylene Glycol | Pluriol E4000² | 14.41 | 0 |
| | Pluriol E8000^{2a} | 0 | 14.41 |
| Sodium | | 27 | 27 |
| CitrateDihydrate | | | |
| Sodium | | 1 | 1 |
| Carboxymethyl | | | |
| Cellulose 95% | | | |
| Stilbene Disulfonic | | 0.1 | 0.1 |
| Acid | | | |
| Sodium Polyacrylate | | 2.25 | 2.25 |
| Sodium carbonate | | 2.39 | 2.39 |
| Silicone Defoamer | | 0.01 | 0.01 |
| Sodium Percarbonate, | FB 400 C⁴ | 20 | 20 |
| encapsulated | | | |
| TAED | | 9.84 | 9.84 |
| Enzyme | Purafect 4000L⁵ | 1 | 1 |
| Alcohol Ethoxylate: | | 1.53 | 1.53 |
| PEG 4000 ratio | | | |
| Satisfactory Block | | Yes | No - Too brittle |

¹Available from BASF
²Available from BASF having a molecular weight of 4,000
^{2a}Available from BASF having a molecular weight of 8,000
³Available from Thoma (Air Products), laureth/myristeth-7, a liquid alcohol ethoxylate
⁴Coated sodium percarbonate available from Solvay
⁵Available from Genencor

Composition 2 produced a satisfactory solid block whereas Comparative Composition B produced a block which was too brittle for packaging and transport.

### Example 3

Composition 3 and Comparative Composition C were prepared according to the formulae provided in the table below. This Example shows that suitable solid block detergents were prepared using a liquid iso-type alcohol ethoxylate and polyethylene glycol having a molecular weight of 4,000 (PEG 4000). Trading the PEG 4000 with PEG 8000 did not result in an acceptable solid block detergent.

| | | | Comparative |
|---|---|---|---|
| | | Composition | Composition |
| Component | Tradename | 3 Wt-% | C Wt-% |
| Alcohol ethoxylate | Genopol ID 060¹ | 22 | 22 |
| Polyethylene Glycol | Pluriol E4000² | 14.41 | 0 |
| | Pluriol E8000^{2a} | 0 | 14.41 |
| Sodium | | 27 | 27 |
| CitrateDihydrate | | | |
| Sodium | | 1 | 1 |
| Carboxymethyl | | | |
| Cellulose 95% | | | |
| Stilbene Disulfonic | | 0.1 | 0.1 |
| Acid | | | |
| Sodium Polyacrylate | | 2.25 | 2.25 |
| Sodium carbonate | | 2.39 | 2.39 |
| Silicone Defoamer | | 0.01 | 0.01 |
| Sodium Percarbonate, | FB 400 C⁴ | 20 | 20 |
| encapsulated | | | |
| TAED, | | 9.84 | 9.84 |
| Enzyme | Purafect 4000L⁵ | 1 | 1 |
| Alcohol Ethoxylate: | | 1.53 | 1.53 |
| PEG 4000 ratio | | | |
| Satisfactory Block | | Yes | No - Too brittle |

¹Available from Clariant
²Available from BASF having a molecular weight of 4,000
^{2a}Available from BASF having a molecular weight of 8,000
³Available from Thoma (Air Products), laureth/myristeth-7, a liquid alcohol ethoxylate
⁴Coated sodium percarbonate available from Solvay
⁵Available from Genencor

Composition 3 produced a satisfactory solid block whereas Comparative Composition C produced a block which was too brittle for packaging and transport.

### Example 4

Composition 4 and Comparative Composition D were prepared according to the formulae provided in the table below. This Example shows that suitable solid block detergents were prepared using a laureth/myristeth-7, a liquid alcohol ethoxylate and polyethylene glycol having a molecular weight of 4,000 (PEG 4000). Trading the PEG 4000 with PEG 8000 did not result in an acceptable solid block detergent.

| | | | Comparative |
|---|---|---|---|
| | | Composition | Composition |
| Component | Tradename | 4 Wt-% | D Wt-% |
| Alcohol ethoxylate | Surfonic 24-7¹ | 31.7 | 31.7 |
| Polyethylene Glycol | Pluriol E4000² | 8.5 | 0 |
| | Pluriol E8000^{2a} | 0 | 8.5 |
| Sodium | | 26.21 | 26.21 |
| CitrateDihydrate | | | |
| Sodium | | 1 | 1 |
| Carboxymethyl | | | |
| Cellulose 95% | | | |
| Stilbene Disulfonic | | 0.1 | 0.1 |
| Acid | | | |
| Sodium Polyacrylate | | 2.25 | 2.25 |
| Sodium carbonate | | 2.39 | 2.39 |
| Silicone Defoamer | | 0.01 | 0.01 |
| Sodium Percarbonate, | FB 400 C⁴ | 18 | 18 |
| encapsulated | | | |
| TAED | | 8.84 | 8.84 |
| Enzyme | Purafect 4000L⁵ | 1 | 1 |
| Alcohol Ethoxylate: | | 3.73 | 3.73 |
| PEG 4000 ratio | | | |
| Satisfactory Block | | Yes | No - Too brittle |

¹Available from Huntsman
²Available from BASF having a molecular weight of 4,000
^{2a}Available from BASF having a molecular weight of 8,000
³Available from Thoma (Air Products), laureth/myristeth-7, a liquid alcohol ethoxylate
⁴Coated sodium percarbonate available from Solvay
⁵Available from Genencor

Composition 4 produced a satisfactory solid block whereas Comparative Composition D produced a block which was too brittle for packaging and transport.

### Example 5

Composition 5 and Comparative Composition E were prepared according to the formulae provided in the table below. This Example shows that suitable solid block detergents were prepared using a liquid Guerbet type branched alcohol ethoxylate and polyethylene glycol having a molecular weight of 4,000 (PEG 4000). Trading the PEG 4000 with PEG 8000 did not result in an acceptable solid block detergent.

| | | | Comparative |
|---|---|---|---|
| | | Composition | Composition |
| Component | Tradename | 5 Wt-% | E Wt-% |
| Alcohol ethoxylate | Lutensol XP50¹ | 31.7 | 31.7 |
| Polyethylene Glycol | Pluriol E4000² | 8.5 | 0 |
| | Pluriol E8000^{2a} | 0 | 8.5 |
| Sodium | | 26.21 | 26.21 |
| CitrateDihydrate | | | |
| Sodium | | 1 | 1 |
| Carboxymethyl | | | |
| Cellulose 95% | | | |
| Stilbene Disulfonic | | 0.1 | 0.1 |
| Acid | | | |
| Sodium Polyacrylate | | 2.25 | 2.25 |
| Sodium carbonate | | 2.39 | 2.39 |
| Silicone Defoamer | | 0.01 | 0.01 |
| Sodium Percarbonate, | FB 400 C⁴ | 18 | 18 |
| encapsulated | | | |
| TAED | | 8.84 | 8.84 |
| Enzyme | Purafect 4000L⁵ | 1 | 1 |
| Alcohol Ethoxylate: | | 3.73 | 3.73 |
| PEG 4000 ratio | | | |
| Satisfactory Block | | Yes | No - Too brittle |

¹Available from Huntsman
²Available from BASF having a molecular weight of 4,000
^{2a}Available from BASF having a molecular weight of 8,000
³Available from Thoma (Air Products), laureth/myristeth-7, a liquid alcohol ethoxylate
⁴Coated sodium percarbonate available from Solvay
⁵Available from Genencor

Composition 5 produced a satisfactory solid block whereas Comparative Composition E produced a block which was too brittle for packaging and transport.

### Example 6

Composition 6 and Comparative Composition F were prepared according to the formulae provided in the table below. This Example shows that suitable solid block detergents were prepared using a liquid iso-type alcohol ethoxylate and polyethylene glycol having a molecular weight of 4,000 (PEG 4000). Trading the PEG 4000 with PEG 8000 did not result in an acceptable solid block detergent.

| | | | Comparative |
|---|---|---|---|
| | | Composition | Composition |
| Component | Tradename | 6 Wt-% | F Wt-% |
| Alcohol ethoxylate | Genopol 060¹ | 31.7 | 31.7 |
| Polyethylene Glycol | Pluriol E4000² | 8.5 | 0 |
| | Pluriol E8000^{2a} | 0 | 8.5 |
| Sodium | | 26.21 | 26.21 |
| CitrateDihydrate | | | |
| Sodium | | 1 | 1 |
| Carboxymethyl | | | |
| Cellulose 95% | | | |
| Stilbene Disulfonic | | 0.1 | 0.1 |
| Acid | | | |
| Sodium Polyacrylate | | 2.25 | 2.25 |
| Sodium carbonate | | 2.39 | 2.39 |
| Silicone Defoamer | | 0.01 | 0.01 |
| Sodium Percarbonate, | FB 400 C⁴ | 18 | 18 |
| encapsulated | | | |
| TAED | | 8.84 | 8.84 |
| Enzyme | Purafect 4000L⁵ | 1 | 1 |
| Alcohol Ethoxylate: | | 3.73 | 3.73 |
| PEG 4000 ratio | | | |
| Satisfactory Block | | Yes | No - Too brittle |

¹Available from Clariant
²Available from BASF having a molecular weight of 4,000
^{2a}Available from BASF having a molecular weight of 8,000
³Available from Thoma (Air Products), laureth/myristeth-7, a liquid alcohol ethoxylate
⁴Coated sodium percarbonate available from Solvay
⁵Available from Genencor

Composition 6 produced a satisfactory solid block whereas Comparative Composition F produced a block which was too brittle for packaging and transport.

### Example 7

The following compositions were prepared according to the invention:

| | | Composition | Composition |
|---|---|---|---|
| Component | Tradename | 7 Wt-% | 8 Wt-% |
| Alcohol ethoxylate | Lutensol XP50¹ | 17 | 17 |
| Polyethylene Glycol | Pluracal E4000² | 16.41 | 16.41 |
| 4000 | | | |
| Alcohol ethoxylate | Tomadol 25-7³ | 5 | 5 |
| Sodium | | 25 | 12 |
| CitrateDihydrate | | | |
| Sodium | | 1 | 1 |
| Carboxymethyl | | | |
| Cellulose | | | |
| Sodium Chloride | | — | 13 |
| Stilbene Disulfonic | | 0.1 | 0.1 |
| Acid | | | |
| Sodium Polyacrylate | | 2.25 | 2.25 |
| Sodium carbonate | | 2.39 | 2.39 |
| Silicone Defoamer | | 0.01 | |
| Sodium Percarbonate, | FB 400 C⁴ | 20 | 20 |
| encapsulated | | | |
| TAED | | 9.84 | 9.84 |
| Enzyme | Purafect 4000L⁵ | 1 | 1 |
| Alcohol Ethoxylate: | | 1.34 | 1.34 |
| PEG 4000 ratio | | | |
| Satisfactory Block | | Yes | Yes |

¹Available from BASF, a Guerbet type, liquid branched alcohol ethoxylate
²Available from BASF
³Available from Thoma (Air Products), laureth/myristeth-7, a liquid alcohol ethoxylate
⁴Coated sodium percarbonate available from Solvay
⁵Available from Genencor

Solid blocks were prepared according to the formulations provided above as Compositions 7 and 8. Both Composition 7 and 8 produced satisfactory blocks exhibiting satisfactory results in each of the above-mentioned tests. That is, the blocks remained solid both at elevated temperatures and after cooling to ambient temperatures with acceptable physical stability over 28 days having minimal to no separation. The compositions adequately removed soil from fabric swatches.

### Example 8

Detergency or Soil Removal of a Sample of Composition 8 was compared against a commercially available solid detergent sample available as Wash 'N Bleach Extra 2 from Noramtech, hereinafter Comparative G. A chemical analysis was run on the commercially available detergent and was found to have the following composition:

| | Comparative Composition G |
|---|---|
| Ingredient | Percent by weight |
| Surfactants | 41.9 |
| Sodium Percarbonate | 29.0 |
| TAED | 11.0 |
| Sodium Chloride | 14.0 |
| Sodium 1,2-octane disulfate | 3.0 |
| Enzyme & sodium metasilicate | 1.0 |
| Water | 1.0 |

Seven cotton swatches, each having a unique soil were washed in duplicate using Sample 8 and Comparative Composition G according to the above-provided protocol. The soils on the cotton swatches were lipstick, makeup, dirty motor oil, olive oil with carbon black, tea, curry, and immedial black dye. Three polyester/cotton blend swatches, each having a unique soil were also washed in duplicate using Composition8 and Comparative Composition G according to the above-provided protocol. The soils on the poly/cotton swatches were dust on sebum, olive oil with carbon black, and strawberry.

Composition 8 prepared according to an embodiment of the invention performed as least as good as or better than Comparative Sample G on all of the soil samples.

### Example 9

Example 8 was repeated using Composition 8 that had been held under the cycling conditions for 30 days. Soil removal and detergency remained stable even after the harsh holding conditions.

### Example 10

The pH of Composition 8 was tested weekly during the 100° F. storage and the Cycling Condition storage. The initial pH of a 1% dilution in water was just below 10.2. After week 1, the pH of the 100° F. storage was about 10.17, the 122° F. storage was about 10.1. Week 2, 100° F. was 10.18; 122° F. was 10.1; week 3100° F. was 10.08, 122° F. was 10.1; Week 4 at 100° F. was 10.08 and 122° F. was 10.0. Therefore, the samples maintained a pH of at least 10 up to about 10.2 even during harsh conditions.

In contrast, the pH of Comparative Composition G was also tested as described above. While the 100° F. sample remained relatively stable (slight decrease in pH) at around 9.85 over the 4 week period, the pH of 122° F. sample dropped dramatically to 9 after week 1, 8.8 after week 2, 8.65 after week 3, and 8.1 after week 4. Thus, it was demonstrated that the pH of compositions prepared according to the invention remained relatively stable as compared to a commercially available solid.

1. A detergent composition, comprising:
an alcohol ethoxylate surfactant,
a hardening agent consisting of polyethylene glycol 4000 wherein the weight ratio of surfactant to polyethylene glycol 4000 is 3.7:1 to 2.5:1;
and wherein the composition does not include any free water, the composition is substantially free of alkali metal hydroxides, and the detergent is formed in a solid block.

2. The detergent composition of claim 1 further comprising filler.

3. The detergent composition of claim 1 further comprising a water conditioner or a sequestrant or a combination thereof.

4. The detergent composition of claim 1 further comprising a bleach and a bleach activator.

5. The detergent composition of claim 1 wherein the solid is an amorphous solid.

6. The detergent composition of claim 4 wherein the bleach or the bleach activator or both are encapsulated.

7. The detergent composition of claim 1 further optionally comprising optical brightener, defoamer, enzyme, antiredeposition agent, buffering agent, stabilizer or combinations thereof.

8. The detergent composition of claim 3 wherein the sequestrant is comprised of sodium citrate dihydrate.

9. The detergent composition of claim 7 wherein the brightener comprises stilbene disulfonic acid.

10. The detergent composition of claim 1 wherein the bleach and bleach activator comprises sodium percarbonate and tetraacetylethylenediamine.

11. The detergent composition of claim 1 wherein the weight ratio of surfactant to polyethylene glycol 4000 is 1.5:1 or less.

12. A method of preparing a solid detergent composition, the steps comprising:
(a) mixing a fluid detergent composition at shear sufficient to mix the fluid detergent composition having a viscosity of between about 4,000 and about 8,000 cps in a flowable consistency, the detergent composition comprising:
(i) a alcohol ethoxylate surfactant,
(ii) a hardening agent consisting of polyethylene glycol 4000;
wherein the composition does not include any free water or alkali metal hydroxides or phosphate;
(b) depositing the detergent composition into molds; and
(c) allowing the detergent composition to solidify at a time of between about 1 minute and about 3 hours.

13. The detergent composition of claim 12 further comprising filler.

14. The detergent composition of claim 12 further comprising a water conditioner, or a bleach and a bleach activator, or combinations thereof.

15. The detergent composition of claim 12 further comprising a sequestrant.

16. The detergent composition of claim 13 wherein the solid is an amorphous solid.

17. The detergent composition of claim 12 wherein the crystal modifier is comprised of sodium xylene sulfonate.

18. The detergent composition of claim 12 further optionally comprising optical brightener, defoamer, enzyme, antiredeposition agent, buffering agent, stabilizer or combinations thereof.

19. The detergent composition of claim 15 wherein the sequestrant is comprised of sodium citrate dihydrate.

20. The detergent composition of claim 18 wherein the brightener comprises stilbene disulfonic acid.

21. The detergent composition of claim 14 wherein the bleach and bleach activator comprises sodium percarbonate and tetraacetylethylenediamine.

22. A method according to claim 12, wherein the step of solidifying the fluid detergent composition to a solid form comprises at least one of cooling the fluid detergent composition and allowing a chemical reaction within the fluid detergent composition.

23. A method according to claim 12, wherein the step of solidifying comprises casting the fluid detergent composition into a mold.

24. A method according to claim 12, wherein the step of solidifying comprises extruding the fluid detergent composition.

25. A method according to claim 12, wherein the composition is provided in the form of a block.

26. A method of preparing a solid detergent composition, the steps comprising:
mixing a fluid detergent composition at shear sufficient to mix the fluid detergent composition having a viscosity of between about 4,000 and about 8,000 cps in a flowable consistency, the detergent composition comprising:
(i) an alcohol ethoxylate surfactant,
(ii) a hardening agent consisting of polyethylene glycol 4000;
wherein the composition does not include any free water and does not include any alkali metal hydroxides;
extruding the detergent composition; and
allowing the detergent composition to solidify at a time of between about 1 minute and about 3 hours.

27. A detergent composition, comprising:
10 to 40 weight percent alcohol ethoxylate surfactant,
5 to 35 weight percent hardening agent consisting of polyethylene glycol 4000 wherein the weight ratio of surfactant to polyethylene glycol 4000 is 3.7:1 to 2.5:1,
and wherein the composition does not include any free water, the composition is substantially free of alkali metal hydroxides, the composition is substantially free of phosphate, and the detergent is formed in a solid block.
